(19) United States
(12) Patent Application Publication
(10) Pub. No.: US 2024/0345606 A1
(43) Pub. Date: Oct. 17, 2024

(54) Water Utility Demand Management for Reduction of Electrical Energy Consumption

(71) Applicant: Aquana LLC, Warren, VT (US)

(72) Inventors: Everett S MCGINLEY, Montgomery, VT (US); Steven ASKEW, Warren, VT (US)

(73) Assignee: Aquana LLC, Warren, VT (US)

(21) Appl. No.: 18/636,929

(22) Filed: Apr. 16, 2024

Related U.S. Application Data
(60) Provisional application No. 63/496,434, filed on Apr. 17, 2023.

(51) Int. Cl. G05D 7/06; E03B 7/07; G05D 7/00

(52) U.S. Cl. CPC G05D 7/0676; E03B 7/075; G05D 7/005

(57) ABSTRACT

A water management system includes a demand response controller. The demand response controller configured to receive a demand response signal that specifies a reduction in electrical power consumption by a water utility. The demand response controller is also configured to select a point of use device (PUD) to implement a reduction in water consumption responsive to the demand response signal. The demand response controller is further configured to transmit, to the PUD, a control signal that specifies a reduction in water flow controlled by the PUD.

### CROSS-REFERENCE TO RELATED APPLICATIONS

This application claims priority to U.S. provisional application No. 63/496,434, filed Apr. 17, 2023, entitled “Water Utility Demand Management for Reduction of Electrical Energy Consumption,” which is incorporated herein by reference in its entirety.

### BACKGROUND

Water utilities are under economic, market, and regulatory pressure to reduce energy consumption and cost. Water utilities use large amounts of electrical power for pumping and purification, up to 40% of their operating expense in some instances. Accordingly, energy use is an important factor in water utility operation.

### SUMMARY

This disclosure relates to a system enabling water utilities to manage the consumption of water at points of use in order to reduce its electrical energy consumption in response to a signal requiring such a reduction from an electrical utility or third-party electrical demand aggregator.

The water management system disclosed herein enables water utilities to implement effective water demand response systems. The system provides point of use specific flow reduction or shut off capability, as well as dynamic bidirectional control signal transmissions to implement and terminate the demand response condition.

In one example, a water management system includes a demand response controller. The demand response controller is configured to receive a demand response signal that specifies a reduction in electrical power consumption by a water utility. The demand response controller is also configured to select a point of use device (PUD) to implement a reduction in water consumption responsive to the demand response signal. The demand response controller is further configured to transmit, to the PUD, a control signal that specifies a reduction in water flow controlled by the PUD.

In another example, a method for water management includes receiving, by a demand response controller, a demand response signal that specifies a reduction in electrical power consumption by a water utility. The method also includes selecting, by the demand response controller, a PUD to implement a reduction in water consumption responsive to the demand response signal. The method further includes transmitting, by the demand response controller, to the PUD, a control signal that specifies a reduction in water flow controlled by the PUD.

In a further example, a non-transitory computer-readable medium is encoded with instructions that are executable by a processor to cause the processor to receive a demand response signal that specifies a reduction in electrical power consumption by a water utility. The instructions also cause the processor to select a PUD to implement a reduction in water consumption responsive to the demand response signal. The instructions further cause the processor to transmit, to the PUD, a control signal that specifies a reduction in water flow controlled by the PUD.

### BRIEF DESCRIPTION OF THE DRAWINGS

FIG. 1 is a block diagram of an example water management system that includes demand response control.

FIG. 2 is a flow diagram of an example method for demand response control of electrical power consumption in a water utility.

FIG. 3 is a block diagram for an example computing node suitable for use in the water management system of FIG. 1.

### DETAILED DESCRIPTION

Water utilities are increasingly subject to power curtailment by electrical utilities and may enroll in electrical utility demand response programs to reduce power consumption at peak electrical demand periods. Electrical demand response signaling is dynamic and can change in near real time in response to shortage of energy available from the grid, reduction in generation capacity, or a temporary increase in the price of purchased energy. In order to effectively respond to electrical demand response requirements, water utilities need to develop water demand response systems to dynamically manage water consumption. A steady state, dynamic, or seasonal reduction in energy consumption may be accomplished by limiting pumping and system pressure in distribution lines where consumption is low based on dynamic water point of use consumption control or scheduled flow restrictions in the distribution line.

An important element of a demand response system is point of use control. For example, in a demand response system implemented by an electrical utility, it is not acceptable for safety or comfort reasons to shut off power to an entire home, apartment, or building, as would happen if the electrical meter were used as a disconnect device. Rather, a consuming device controller has some capability to react to control signals and reduce or eliminate usage during a demand response event. Alternatively, the consuming device controller may have the ability to be programmed to reduce or eliminate consumption on a time-of-day basis or even be manually turned off in response to a demand response event communication sent to the owner. At present, water utilities have largely not implemented point of use control.

Many water utilities participate in electrical demand response systems to reduce their considerable electrical consumption for pumping and purification during electrical demand response events. Water utilities are compensated by their electrical utilities for the reduction in energy consumption. However, with no way to dynamically reduce the consumption of water through point of use control, the ability to respond is largely limited to load shifting by changing pumping schedules without control over or knowledge of consumption.

In the water management systems described herein, reduction of excess water consumption and accompanying excess energy consumption is accomplished using point of use flow controllers communicating with a central management system which can implement scheduled or regulatory demand restrictions and point of use specific consumption profiles, and which can react dynamically to electrical demand response signals, external events, and changing conditions. Point of use flow control devices may also be programmed to act autonomously in response to sensor inputs to eliminate or reduce flow in the event of a leak or burst event, to maintain consumption within a designated point of use profile, or to eliminate excess water consumption.

Implementation of flow reduction, rather than implementation of shut off capability alone, allows designated points of consumption to function at reduced flow rates when required, for example toilet filling, showering, or industrial processes such as washing and rinsing, whereas shutting these points of consumption off completely could be unacceptable. Other points of consumption, such as irrigation, may be shut off completely for the duration of the demand response event.

A further advantage of dynamic water point of use control relates to safety. Should water flow be required for firefighting, for instance, full flow can quickly (e.g., in a few minutes) be restored. The water control system can be integrated with a building's fire alarm system or other building or industrial process control systems to automatically turn on or off full flow in the event of an alarm or other condition or event.

In some examples, water dynamic point of use control may also enable implementation of a water utility water demand response system. Such a system can enable the water utility to dynamically reduce water consumption in response to a purchased water shortage or temporary price increase, a need to reduce water draw from a reservoir or other water body, a need to reduce consumption due to a weather event, a system failure or major leakage event, or to change time-of-day consumption profile, for instance for irrigation, or to avoid demand exceeding pumping, transmission, or purification capacity. The same communications and point of use control capacity can be used to implement regulatory restrictions on consumption, for instance mandatory reduction or scheduling of irrigation or pool filling and to enforce compliance with these restrictions, including reprogramming when restrictions change.

A water utility demand response system may also be used to reduce water and energy consumption caused by point of use leaks (leaking fixtures and interior piping) and unnecessary or wasteful point of use consumption as well as distribution system leaks, all of which require additional pumping energy to overcome pressure loss.

Accordingly, the water management systems of the present disclosure implement water point of use controls and the ability to send control signals to water points of use that enable water utilities to implement a known amount of water consumption reduction in near real time in a specific distribution line and thus achieve a larger reduction in pumping electrical consumption in that line. This allows the water utility to respond to electrical demand management signals with larger power reductions and achieve larger cost savings.

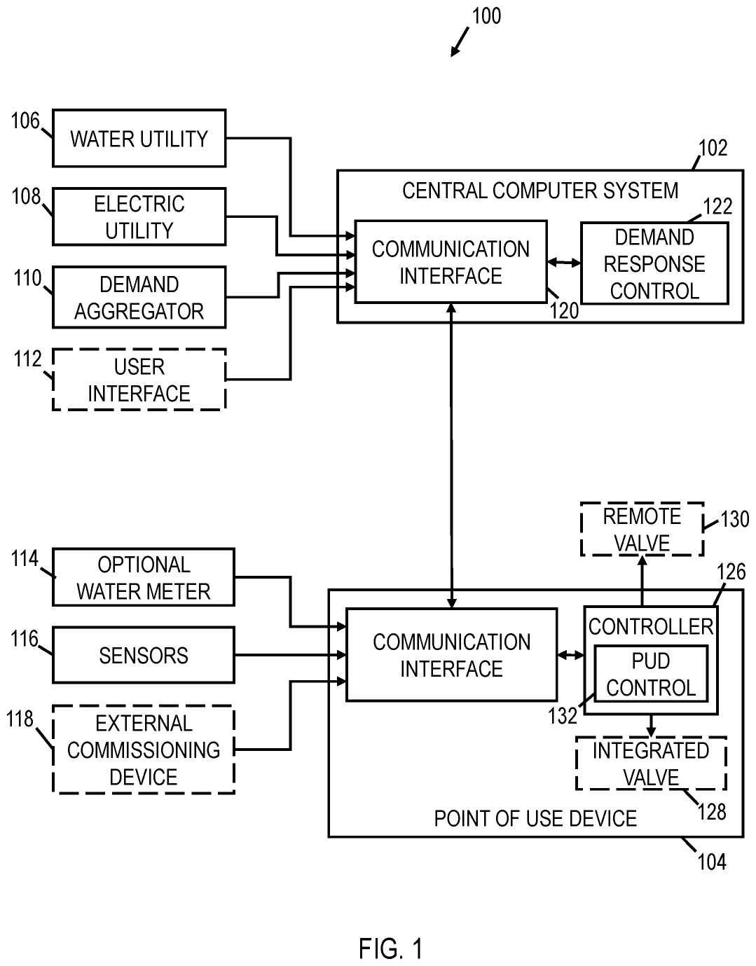

FIG. 1 is a block diagram of an example water management system 100 configured to implement demand response control in a water utility system. The water management system 100 includes a central computer system 102 and a point-of-use device (PUD) 104. The central computer system 102 is configured to implement a demand response controller by execution of a demand response control application 122. The central computer system 102 is communicatively coupled to the PUD 104, a water utility 106, an electric utility 108, a third-party electrical demand aggregator 110, and/or a user interface 112 via a communication interface 120. The communication interface 120 may be configured to provide communication between the central computer system 102 and the PUD 104, the water utility 106, the electric utility 108, the third-party electrical demand aggregator 110, and/or the user interface 112 using a wired or wireless communication network, for example, the internet, and an internet cloud infrastructure.

The central computer system 102 receives, via the communication interface 120, signals from the electric utility 108 or the third-party electrical demand aggregator 110 (demand response signals) indicating an electrical demand response event requiring the water utility 106 to reduce electrical consumption. Such demand response signals may request an immediate response or may definitively indicate or conditionally forecast a future demand response event allowing the water utility 106 additional time to prepare for same. Alternately, the central computer system 102, via the communication interface 120, receives signals from the water utility 106 indicating that it is implementing a demand response event. The demand response signals may simply indicate a general demand response event or specify levels or types of demand response events. Communication with the water utility 106 may include communication with a third party system that provides water use measurements (e.g., meter readings) or other water utility related information. Functionality described here with respect to the water utility 106 may be performed by the third party system, where the third party system may communicate with the water utility 106 and/or the central computer system 102.

Programming (instructions) of the demand response control application 122 stored in memory or otherwise provided to the central computer system 102 (also referred to as central system software) includes a record of the points of use provided in the water management system 100 (including the PUD 104), and the characteristics of the points of use. The central computer system 102, by execution of the demand response control application 122, selects specific points of use to control in response to the demand response signals. The demand response control application 122 may cause the central computer system 102 to select shut off or partial flow restrictions and/or durations thereof. The demand response control application 122 may include algorithms to compute the necessary point of use instructions to achieve the desired level of electrical demand reduction. The demand response control application 122 may include an interface to the control system of the water utility 106 and its software (a water utility interface) to enable and update the record of points of consumption and their operational status or characteristics, including in some embodiments a spatial or other relational map of such points of control. The demand response control application 122 may compute a point of use profile including expected or permitted levels of flow which may vary with time of day or season. The demand response control application 122 may also receive point of use profile information from the control system of the water utility 106 and may have machine learning or artificial intelligence capability to enable such software to learn the consumption profile of points of use in order to formulate a point of use profile.

For points of use that are selected for flow reductions rather than total shut off during a demand response event, the demand response control application 122 may record durations where such point of use demands the full amount of the reduced flow setting during a portion of or the entire demand response event and autonomously adjust such reduced flow setting for future demand response events according to its machine learning or artificial intelligence capabilities. Alternately, the demand response control application 122 may notify the water utility 106 of such a condition through the water utility interface allowing the water utility 106 to manually adjust such parameters.

The demand response control application 122 enables water utility operators to establish desired operating parameters such as implementing a demand response event, time of day consumption, scheduled consumption, reduced flow conditions, or leak detection response. Such parameters may pertain to control of groups of points of use in district metered areas or zones. The demand response control application 122 may have machine learning or artificial intelligence capability to enable the demand response control application 122 to learn the consumption profile of points of use or other sensor inputs and respond autonomously or communicate with other systems (such as the water utility 106 or the user interface 112) if consumption or sensor input exceeds the profile envelope, where the profile envelope defines water consumption or sensor output thresholds. The demand response control application 122 may be able to evaluate point of use flow data and determine the amount that pumping pressure may be reduced in a distribution line to maintain and preserve pumping capacity within desired limits while reducing electrical energy consumption. The demand response control application 122 may be used to update the firmware of the PUD 104 and/or any sensors coupled thereto. The demand response control application 122 may evaluate external factors such as actual and forecast weather or other disturbances and adjust programmed usage or restrictions accordingly, for instance shutting off irrigation points of use during local rain events or frost warnings.

The demand response control application 122 may also include instructions that provide information to or receive information from the user interface 112 for communication with building owners or occupants or those responsible for points of consumption (users). The capabilities and privileges of the user interface may be determined by the water utility operator or by other input to the demand response control application 122. The user interface may allow users to see actual, historical, and scheduled consumption, flow rates, receive notices of demand response events, system malfunctions, leaks, out of profile envelope consumption, values of other sensors such as temperature, and point of use or total consumption data, including billing data. The user interface may provide for two-way communication enabling users to remotely shut off or restrict flow at points of use, schedule point of use consumption, request service, or request an exemption to a demand response event restriction or terminate participation in a voluntary demand response program.

The demand response control application 122 may manage the enrollment of end points (e.g., the PUD 104) in a voluntary or mandatory demand response program and provide information regarding the enrollment to an external system (e.g., the water utility 106) for use with billing data and billing services.

The demand response control application 122 may be designed for an enterprise rather than a residential or end-user application in order to be acceptable and useful to the water utility 106. The water management system 100 may have the ability to integrate with other smart city and smart building systems. The demand response control application 122 may be structured to enable the enterprise to securely assign permissions and privileges across many levels and have robust error handling, data throughput, cloud communication, and cyber security capabilities.

The communication interface 120 provides communication between the central computer system and the PUD 104. Such communication may utilize an internet cloud infrastructure to connect to a wired connection or any type of wireless connection with sufficient data communication capacity, for example LoRaWAN, cellular, Wi-Fi, Bluetooth, or proprietary radio frequency systems.

The PUD 104 includes a communication interface 124 and a controller 126 coupled to the communications interface 124. The communication interface 124 is communicatively coupled to the communication interface 120 of the central computer system 102 via one or more of the networking technologies noted above. The controller 126 is coupled to the communication interface 124 and to a flow control device, such as a valve. The controller 126 is configured to actuate the valve responsive to control signals received from the central computer system 102 or generated internal to the PUD 104.

Actuation of the valve by the controller 126 may include fully or partially closing the valve to shut off or reduce flow through the valve. In some examples, the PUD 104 includes the valve 128 coupled to and actuated by the controller 126. In other examples, the valve 130 is provided external to the PUD 104, and the controller 126 controls the valve 130 via a communication medium, such as electrical conductors.

The PUD 104 receives control signals or routines from the central computer system 102 via a wireless connection, for example LoRaWAN, cellular, Wi-Fi, Bluetooth, or from a wired connection to the internet. The PUD 104 may be positioned at the water service entrance to a building or facility, such as a curb stop, or preferably an instance of the PUD 104 may be located at individual points of consumption. The PUD 104 may be able to communicate data from specific points of consumption and sensor data to the central computer system 102 through its internet connection or through local connections which may then connect with the central computer system 102. The PUD 104 may include or be coupled to optional sensors 116, for example a temperature sensor for freeze protection or a flow sensor capable of detecting leaks. The sensors 116 may have wired or wireless connections to the PUD 104. The PUD 104 may also have an integral wireless router or Wi-Fi or other protocol client to support connections to other devices in a “smart building” system. The PUD 104 may include an integrated processor (e.g., the controller 126). The controller 126 includes storage (e.g., memory) in which a PUD control application 132 is provided. The PUD control application 132 includes instructions that are executed by the controller 126 to provide the PUD functionality described herein. For example, the PUD control application 132 may include instructions and algorithms for evaluating sensor input, and responding autonomously to those sensor inputs. The PUD control application 132 may have machine learning or artificial intelligence capability to enable the PUD 104 to learn the consumption profile of points of use or other sensor inputs and respond autonomously or communicate with the central computer system 102 if consumption or sensor input exceeds the profile envelope.

The PUD control application 132 may include instructions for providing a commissioning system that communicates with an external commissioning device 118 enabling the PUD 104 to be calibrated and to associate flow of designated points of consumption with sensor input, including meter consumption data to enable the PUD 104 to differentiate between flows at those points of consumption even if they are connected to a single piping branch. The external communication device 118 may be a mobile device such as a cell phone or a tablet, and may communicate with the PUD 104 via cellular service or Bluetooth or other wireless or wired communication devices to provision or service the PUD 104 and enable the association with specific points of consumption or for the installation of the PUD 104 or sensor firmware updates. The commissioning system may also communicate with the central computer system 102 and the central system software to enable remote commissioning.

In some implementations of the water management system 100, the PUD 104 may include or be coupled to an optional water meter 114. The PUD 104 may communicate with the water meter 114 through a wired or wireless connection. The water meter 114 can be integral with the PUD 104, adjacent, or remote (but supplying the same water branch circuit). Measurements provided by the water meter 114 can be used to calibrate the PUD 104 or calibrate flow rates for a given point of use to achieve the desired consumption, detect leaks and system failures and shut off or reduce flow, either autonomously or in response to a signal from the central computer system 102. The water meter 114 may communicate with the water utility 106 through its own communications capability, receive demand response and other control signals, and communicate these to the PUD 104. The water meter 114 may also receive such demand response and control signals from an independent advanced metering infrastructure system and communicate these to the PUD 104.

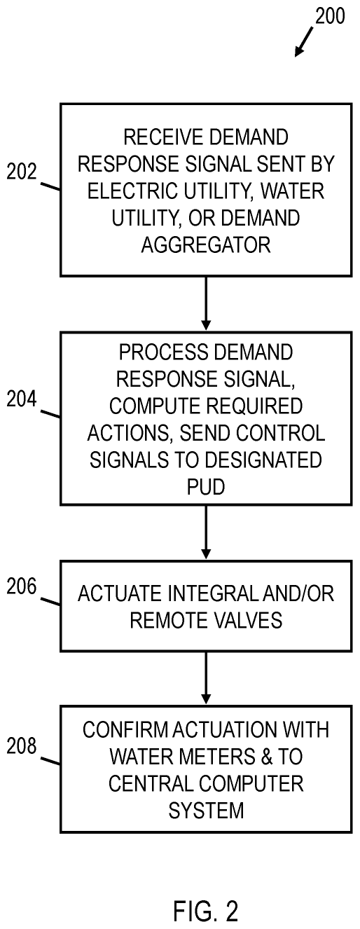

FIG. 2 is a flow diagram of an example method 200 for demand response control of electrical power consumption in a water utility. Though depicted sequentially as a matter of convenience, at least some of the actions shown can be performed in a different order and/or performed in parallel. Additionally, some implementations may perform only some of the actions shown. At least some of the operations of the method may be performed by the water management system 100.

In block 202, the central computer system 102 receives a demand response signal sent by the electric utility 108, the water utility 106, or the third-party electrical demand aggregator 110. More specifically, the communication interface 120 of the central computer system 102 receives the demand response signal, and provides the demand response signal to the demand response control application 122.

In block 204, the demand response control application 122 processes the demand response signal to determine what operations may be required to satisfy the demand response signal. For example, the demand response control application 122 may determine that a reduction of electrical power consumption specified by the demand response signal requires that water consumption be reduced. To implement reduction of water consumption (and thereby reduce electrical power consumption), the demand response control application 122 may select PUDs (e.g., the PUD 104) at which water consumption is to be reduced, and send control signals (via the communication interface 120) to the selected PUDs.

In block 206, the PUDs selected by the demand response control application 122 in block 204, receive the control signals transmitted by the central computer system 102. For example, the PUD 104 receives, via the communication interface 124, the control signal from the central computer system 102, and the communication interface 124 provides the control signal to the controller 126. Responsive to the control signal, the controller 126 (by execution of the PUD control application 132) fully or partially closes the valve 128 and/or the valve 130 to reduce the flow of water through the valve.

In block 208, PUD 104 (by execution of the PUD control application 132) confirms actuation of the valve 128 and/or the valve 130, and reduction in the flow of water therethrough, by communicating with the water meter 114, and retrieving a measurement of water flowing through the water meter 114. The PUD 104 may transmit a confirmation signal to the central computer system 102. The confirmation signal may confirm actuation of the valve 128 and/or the valve 130, and provide the measurement of water flowing through the water meter 114 to the central computer system 102.

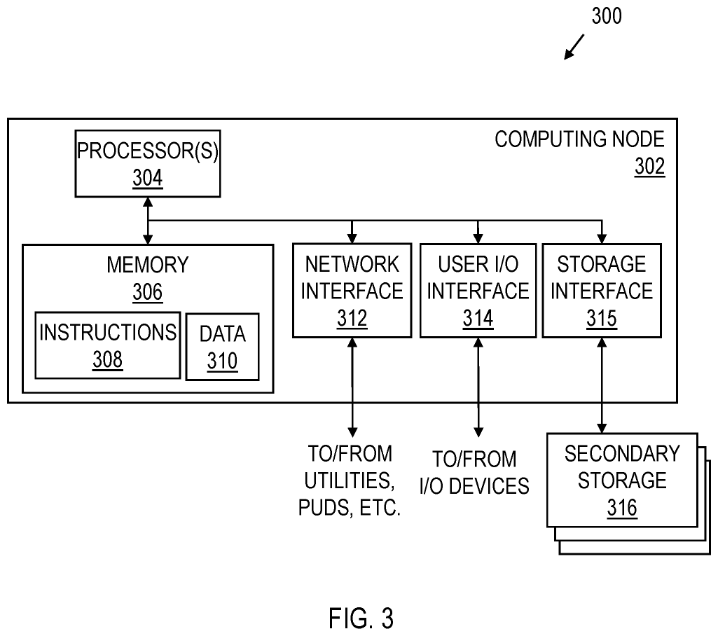

FIG. 3 shows a block diagram for a computing system 300 suitable for use as the central computer system 102 in the water management system 100. The computing system 300 includes one or more computing nodes 302 and secondary storage 316 that are communicatively coupled (e.g., via the storage interface 315). One or more of the computing nodes 302 and associated secondary storage 316 may also be applied to provide the functionality of each of the PUD 104 described herein.

Each computing node 302 includes one or more processors 304 coupled to memory 306, network interface 312, and user I/O interface 314. In various embodiments, a computing node 302 may be a uniprocessor system including one processor 304, or a multiprocessor system including several processors 304 (e.g., two, four, eight, or another suitable number). Processors 304 may be any suitable processor capable of executing instructions. For example, in various embodiments, processors 304 may be general- purpose or embedded microprocessors implementing any of a variety of instruction set architectures (ISAs), such as the x86, PowerPC, SPARC, ARM, or MIPS ISAs, or any other suitable ISA. In multiprocessor systems, each of the processors 304 may commonly, but not necessarily, implement the same ISA.

The memory 306 may include a non-transitory, computer-readable storage medium configured to store program instructions 308 and/or data 310 accessible by processor(s) 304. The memory 306 may be implemented using any suitable memory technology, such as static random-access memory (SRAM), synchronous dynamic RAM (SDRAM), nonvolatile/Flash-type memory, or any other type of memory. Program instructions 308 and data 310 implementing the functionality disclosed herein are stored within memory 306. For example, instructions 308 may include instructions, such as the demand response control application 122 or the PUD control application 132, that when executed by processor(s) 304 implement the demand response controller or the PUD functionality disclosed herein.

Secondary storage 316 may include volatile or non-volatile storage and storage devices for storing information such as program instructions and/or data as described herein for implementing the demand response controller or PUD functionality disclosed herein. The secondary storage 316 may include various types of computer-readable media accessible by the computing node 302 via the storage interface 315. A computer-readable medium may include storage media or memory media such as semiconductor storage, magnetic or optical media, e.g., disk or CD/DVD-ROM, or other storage technologies.

The network interface 312 includes circuitry configured to allow data to be exchanged between computing node 302 and/or other devices coupled to the computing node 302 (such as other computer systems, communication devices, input/output devices, or external storage devices). For example, the network interface 312 may be configured to allow data to be exchanged between a first instance of the computing system 300 configured to operate as the central computer system 102 and a second instance of the computing system 300 configured to operate as the PUD 104. Similarly, the network interface 312 may be configured to allow data to be exchanged between a first instance of the computing system 300 configured to operate as the central computer system 102 and the water utility 106, the electric utility 108, and/or the third-party electrical demand aggregator 110. The network interface 312 may support communication via wired or wireless data networks. The network interface 312 may implement, at least in part, the communication interface 120 of the central computer system 102, and/or the communication interface 124 of the PUD 104.

The user I/O interface 314 allows the computing node 302 to communicate with various input/output devices such as one or more display terminals, keyboards, keypads, touchpads, scanning devices, voice or optical recognition devices, mobile telephones, smartphones, or any other devices suitable for entering or retrieving data by one or more computing nodes 302. Multiple input/output devices may be present in a computing system 300.

Those skilled in the art will appreciate that the computing system 300 is merely illustrative and is not intended to limit the scope of embodiments. In particular, the computing system 300 may include any combination of hardware or software that can perform the functions disclosed herein, including computers, network devices, internet appliances, PDAs, wireless phones, pagers, etc. Computing node 302 may also be connected to other devices that are not illustrated, in some embodiments. In addition, the functionality provided by the illustrated components may in some embodiments be combined in fewer components or distributed in additional components. Similarly, in some embodiments the functionality of some of the illustrated components may not be provided and/or other additional functionality may be available.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A circuit or device that is described herein as including certain components may instead be adapted to be coupled to those components to form the described circuitry or device. For example, a structure described as including one or more elements may be adapted to be coupled to at least some of the elements to form the described structure either at a time of manufacture or after a time of manufacture, for example, by an end-user and/or a third-party.

Circuits described herein are reconfigurable to include additional or different components to provide functionality at least partially similar to functionality available prior to the component replacement.

Modifications are possible in the described embodiments, and other embodiments are possible, within the scope of the claims.

What is claimed is:

1. A water management system comprising:
a demand response controller configured to:
receive a demand response signal that specifies a reduction in electrical power consumption by a water utility;
select a point of use device (PUD) to implement a reduction in water consumption responsive to the demand response signal; and
transmit, to the PUD, a control signal that specifies a reduction in water flow controlled by the PUD.

2. The water management system of claim 1, wherein:
the PUD includes a controller configured to actuate a valve responsive to the control signal, the actuation of the valve including:
partially closing the valve to reduce the water flow responsive to the control signal specifying partial closure; and
fully closing the valve to stop the water flow responsive to the control signal specifying full closure.

3. The water management system of claim 2, wherein the PUD is configured to transmit a confirmation signal to the demand response controller responsive to the actuation of the valve, the confirmation signal specifying whether the valve is partially closed of fully closed.

4. The water management system of claim 2, wherein the PUD is configured to:
receive a water flow measurement from a water meter coupled to the PUD, or from the water utility, responsive to the actuation of the valve; and
transmit a confirmation signal to the demand response controller responsive to the actuation of the valve, the confirmation signal including the water flow measurement.

5. The water management system of claim 2, wherein actuation of the valve includes:
dynamically controlling the valve responsive to the control signal and responsive to water flow measurement data received from a water meter coupled to the PUD, from the water utility, or from a third party system that provides water use measurements.

6. The water management system of claim 1, wherein:
the demand response signal specifies a time at which the reduction in electrical power consumption is to be implemented; and
the demand response controller is configured to schedule transmission of the control signal based on the time.

7. The water management system of claim 1, wherein:
the demand response signal specifies a duration of the reduction in electrical power consumption to be implemented; and
the demand response controller is configured to transmit, to the PUD, a control signal that specifies a resumption of full water flow controlled by the PUD based on expiration of the duration.

8. The water management system of claim 7, wherein the demand response controller is configured to transmit, to the PUD, a control signal that specifies a resumption of full water flow controlled by the PUD, during a portion of the duration of the reduction in electrical power consumption, based on a previously identified requirement for full water flow during the portion of the duration.

9. A method for water management comprising:
receiving, by a demand response controller, a demand response signal that specifies a reduction in electrical power consumption by a water utility;
selecting, by the demand response controller, a point of use device (PUD) to implement a reduction in water consumption responsive to the demand response signal; and
transmitting, by the demand response controller, to the PUD, a control signal that specifies a reduction in water flow controlled by the PUD.

10. The method of claim 9, further comprising:
actuating, by the PUD, a valve responsive to the control signal, the actuation of the valve including:
partially closing the valve to reduce the water flow responsive to the control signal specifying partial closure; and
fully closing the valve to stop the water flow responsive to the control signal specifying full closure.

11. The method of claim 10, further comprising transmitting, by the PUD, a confirmation signal to the demand response controller responsive to the actuation of the valve, the confirmation signal specifying whether the valve is partially closed of fully closed.

12. The method of claim 10, further comprising:
receiving, by the PUD, a water flow measurement from a water meter coupled to the PUD responsive to the actuation of the valve; and
transmitting, by the PUD, a confirmation signal to the demand response controller responsive to the actuation of the valve, the confirmation signal including the water flow measurement.

13. The method of claim 9, wherein:
the demand response signal specifies a time at which the reduction in electrical power consumption is to be implemented; and
the method includes scheduling, by the demand response controller, transmission of the control signal, to the PUD, based on the time.

14. The method of claim 9, wherein:
the demand response signal specifies a duration of the reduction in electrical power consumption to be implemented; and
the method includes transmitting, to the PUD, by the demand response controller, a control signal that specifies a resumption of full water flow controlled by the PUD based on expiration of the duration.

15. The method of claim 14, further comprising transmitting, to the PUD, by the demand response controller, a control signal that specifies a resumption of full water flow controlled by the PUD, during a portion of the duration of the reduction in electrical power consumption based on a previously identified requirement for full water flow during the portion of the duration.

16. A non-transitory computer-readable medium encoded with instructions that are executable by a processor to cause the processor to:
receive a demand response signal that specifies a reduction in electrical power consumption by a water utility;
select a point of use device (PUD) to implement a reduction in water consumption responsive to the demand response signal; and
transmit, to the PUD, a control signal that specifies a reduction in water flow controlled by the PUD.

17. The non-transitory computer-readable medium of claim 16, wherein the instructions are executable by the processor to cause the processor to:
configure the control signal to cause the PUD to partially close a valve to reduce the water flow; and
configure the control signal to cause the PUD to fully close the valve to stop the water flow.

18. The non-transitory computer-readable medium of claim 17, wherein the instructions are executable by the processor to cause the processor to:
receive a confirmation signal from the PUD, the confirmation signal from the PUD;
determine based on the confirmation signal that the valve is closed as specified in the control signal; and
determine based on the confirmation signal, a flow rate of water through the valve.

19. The non-transitory computer-readable medium of claim 17, wherein the instructions are executable by the processor to cause the processor to:
determine, based on the demand response signal, a time at which the reduction in electrical power consumption is to be implemented; and
schedule transmission of the control signal based on the time.

20. The non-transitory computer-readable medium of claim 17, wherein the instructions are executable by the processor to cause the processor to:
determine, based on the demand response signal, a duration of the reduction in electrical power consumption; and
transmit, to the PUD, a control signal that specifies a resumption of full water flow controlled by the PUD based on expiration of the duration.

21. The non-transitory computer-readable medium of claim 20, wherein the instructions are executable by the processor to cause the processor to transmit, to the PUD, a control signal that specifies a resumption of full water flow controlled by the PUD, during a portion of the duration of the reduction in electrical power consumption based on a previously identified requirement for full water flow during the portion of the duration.
